(19) United States
(12) Patent Application Publication
(10) Pub. No.: US 2019/0284106 A1
(43) Pub. Date: Sep. 19, 2019

(54) PRODUCTION OF A PHOSPHATE CONTAINING FERTILIZER

(71) Applicant: KEMIRA OYJ, HELSINKI (FI)

(72) Inventors: Outi GRÖNFORS, ESPOO (FI); Samantha KILJUNEN, ESPOO (FI)

(21) Appl. No.: 16/300,655

(22) PCT Filed: May 17, 2017
(86) PCT No.: PCT/EP2017/061886

§ 371 Date: Nov. 12, 2018

(30) Foreign Application Priority Data
May 18, 2016 (SE) 1650669-3

(51) Int. Cl. C05B 17/00; C05B 19/00; C01B 25/26; C05G 3/00

(52) U.S. Cl. CPC C05B 17/00; C05B 19/00; C01B 25/375; C05G 3/0041; C01B 25/265

(57) ABSTRACT

The present invention relates to a process for the production of a phosphate containing fertilizer product, comprising the steps of providing a phosphate containing precipitate from a wastewater treatment process; separating water from the precipitate to provide a dewatered slurry cake; and optionally admixing a compound selected from nitrogen, potassium and additional phosphorous containing compounds. The present invention further relates to a fertilizer and uses.

### TECHNICAL FIELD

The present invention relates to phosphate containing fertilizers and their manufacture.

### BACKGROUND

The Earth's resources are in many ways limited. A lot of efforts are put on providing sustainable methods for farming of lands. With an increasing population the agricultural demands for large crops are high.

The global high quality phosphate reserves are diminishing in the world. The phosphate reserves are a finite resource and ever-dwindling, and they occur exclusively as phosphate ore. Through an increasing reliance of many industries on phosphate, there is a rapidly growing need for sustainable phosphate management.

According to state of the art phosphorous containing fertilizers are usually prepared by dissolving mined raw phosphorus rich rock with the acids, nitric or sulphuric acid, and to produce phosphoric acid or a slurry for fertilizer production. This process includes many different process steps. The process is very energy demanding and produces a large amount of waste. For example, gypsum waste and undesirable gaseous emissions, such as HF are formed using said process. The use of acids in the process influences the process as it due to low pH leaches out impurities such as heavy metals from the rock. The impurities, like heavy metals, are undesirable in a finished fertilizer product and not suitable to be put onto land, and thus need to be removed by further treatment steps. Further, as the process is operated at very low pH it may cause corrosion on process equipment, and thus, sets high demands for process materials used in the production of fertilizer. The obtained phosphoric acid and/or phosphorous containing slurry is then used as phosphorous source in fertilizer production, e.g. NPK, NP or PK fertilizers, or in the production of single phosphate fertilizers.

US2009/0314046 discloses methods for the production of high phosphorous fertilizer products from waste products. The fertilizer products are obtained via incineration of wastewater treatment sludges.

However, it has now been shown that subjecting the waste products containing phosphorous to high temperatures (above 650° C., e.g. at least 800° C.), will provide an undesirable side effect in that the phosphorus is made less available to plants. As phosphorous is an essential part for the plant administered said fertilizer, it is important that the plant is able to utilize the fertilizer fully, otherwise excessive dosing would be needed. Excessive dosing to compensate for poor availability is also costly for a user.

It would be desirable to obtain new fertilizers and production processes to improve present technology. Thus, it would be desirable to find new, easy, and/or cheaper ways to provide phosphate rich fertilizers which are made readily available for living plants.

### SUMMARY OF THE INVENTION

The present invention relates to fertilizer products and methods for the production of said fertilizer products from waste products, particularly from wastewater treatments, such as industrial and/or municipal wastewater treatments.

The present invention provides methods for the production of fertilizer products containing high amount of phosphorus, obtained from waste products. In particular, the method describes the production of liquid and dry fertilizer products produced from wastewater treatment residues.

According to the present invention the phosphates may not need to be obtained from phosphate containing rocks, instead recycled phosphates may be used as ingoing materials.

Residues or slurries produced from wastewater treatments may contain or may be made to contain high concentrations of phosphorus which is removed from the wastewater treatment process. Said residues or slurries may then be used as an ingoing component for fertilizer production.

The present process differs from known production methods. The present process does not require any acids to dissolve phosphorus. Instead, the recovered inorganic phosphate is ready to be used as a phosphorus source in fertilizer production. The phosphate present in the fertilizer according to the present invention is biologically available, and is citrate soluble, and therefore no acids are needed in said process.

The phosphate of the fertilizer may be recovered from wastewater treatment plants as a slurry, dewatered slurry cake precipitate, or dry particles.

The present fertilizer may be produced from phosphorus rich slurry, dewatered slurry cake, precipitate, or dry particles from industrial and/or municipal sewage treatment plants.

Benefits of the new process compared to the conventional process are cheaper and simpler operation, no acids needed to dissolve the phosphorus as the phosphorus already is soluble in neutral ammonium citrate solution, no toxic gas emissions and no gypsum waste generation. An additional advantage is that it may contain iron which serves as a micronutrient for the plants. The advantage over the single or triple super phosphates is that the final product's pH is close to neutral instead of being below 3 or even below 2, and the product does not acidify the soil.

An object of the present invention is to provide a process for the production of a phosphate containing fertilizer product, comprising the steps of:
providing a phosphate containing precipitate from a wastewater treatment process,
separating water from the precipitate to provide a dewatered slurry cake, and
optionally adding or admixing at least one compound selected from nitrogen, potassium and additional phosphorous containing compounds.

In one embodiment the phosphate containing precipitate may be precipitated from the water phase in a tertiary treatment of the wastewater treatment process.

In one embodiment the phosphate of the phosphate containing precipitate is a salt selected from the group iron phosphates, calcium phosphates, aluminium phosphates, and magnesium ammonium phosphate, such as selected from the group ferric phosphate, ferrous phosphate, iron hydroxide phosphate, monocalcium phosphate, dicalcium phosphate, tricalcium phosphate, calcium hydroxide phosphate, aluminium phosphate, and magnesium ammonium phosphate, e.g. selected from the group ferric phosphate, ferrous phosphate, iron hydroxide phosphate and aluminium phosphate.

In one embodiment the nitrogen containing compounds may be selected from the group urea, ammonium sulphate, methylene urea, ammonia, ammonium chloride, mono ammonium phosphate, diammonium phosphate, ammonium nitrate, potassium nitrate, nitric acid, and nitrogen solutions of UAN (urea and ammonium nitrate and optionally water), and any combination thereof.

In one embodiment the potassium containing compounds may be selected from the group potassium sulphate, potassium chloride, potassium nitrate, potassium phosphate and potassium formiate, and any combination thereof.

In one embodiment the dewatered slurry cake has a dry solids content of 4-80 wt %, preferably selected from any one of the ranges 5-70 wt %, 6-60 wt %, 7-50 wt %, 7-40 wt %, 7-30 wt %, and 8-20 wt %.

In one embodiment the dewatered slurry cake has a phosphorous content calculated on dry solids content of about 4-30 wt %, such as 4-25 wt %, 4-17 wt %, 4-13 wt %, 6-13 wt %, 7-13 wt %, 8-13 wt %, or 8-12 wt %.

In one embodiment the process further comprises a hygienisation step, preferably selected from the group of thermal hygienisation, chemical hygienisation, ozonization, and UV radiation.

In one embodiment the thermal hygienisation is performed at temperatures of about 50-180° C., such as 50-120° C., 50-100° C., 70-95° C., or 70-80° C.

In one embodiment the chemical hygienisation is performed by addition of a compound selected from the group calcium hydroxide, calcium oxide, lime, performic acid, peracetic acid, hydrogen peroxide, and ammonia, and any combination thereof.

In one embodiment the process further comprises the steps of:
optionally mixing said slurry,
optionally adding water, and
pelletizing or granulating the slurry to obtain pellets or granules.

The pelletization and granulation herein is intended to be interpreted as processes which forms the slurry material into manageable units. The manageable units may be disclosed as pellets and/or granules.

In one embodiment the process further comprises the step of drying the dewatered slurry cake and/or the formed pellets or granules.

In one embodiment the dried dewatered slurry cake and/or the optionally dried formed pellets or granules have a dry solids content selected from the group of ranges of 70-100 wt %, 80-99.8 wt %, 90-99.8 wt %, 95-99.8 wt %, and 98-99.5 wt %.

In one embodiment the process further comprises the step(s) of cooling of the pellets or granules and/or screening of the pellets or granules, in any order. In one embodiment the process further comprises the step of cooling of the dried dewatered slurry cake. In one embodiment the process further comprises the step of cooling of the hygienised dewatered slurry cake, e.g. after thermal hygienisation.

In one embodiment the process further comprises the step of coating of the pellets or granules, preferably with a coating comprising a compound selected from the group vegetable oil, mineral oil, palm oil, talc, and mica, and any combination thereof.

An object of the present invention is to provide a fertilizer comprising a phosphate obtained from a wastewater treatment process.

An object of the present invention is to provide a fertilizer obtained from the present process.

An object of the present invention is to provide use of phosphate obtained from a wastewater treatment in the production of a fertilizer.

An object of the present invention is to provide use of a fertilizer, or fertilizer obtained in the present process, on cultivation media, such as soil.

In one embodiment the present process or fertilizer is having the phosphate being any salt including a metal selected from the group calcium, magnesium, iron, aluminium, and any combination thereof, e.g. selected from calcium, iron, and aluminium, and any combination thereof, preferably selected from iron and/or aluminium.

In one embodiment the present process or fertilizer provides said fertilizer with a pH of 5-8, e.g. 5.5-7.5, or 6-7.

### SHORT DESCRIPTION OF THE DRAWINGS

FIG. 1 discloses a schematic view of the process for fertilizer production.

### DETAILED DESCRIPTION

The present invention provides fertilizers and their production methods. The phosphorous containing material to be used to obtain a fertilizer is preferably obtained from a wastewater treatment process. The wastewaters treated may be industrial and/or municipal wastewater. The phosphorous containing material may be a residue or slurry from the wastewater treatment process. A fertilizer may be obtained from a phosphate containing slurry from a wastewater treatment process.

Municipal wastewater treatment plants treat sewage to obtain purified wastewater effluent that can be released to the recipients and meets with the set requirements. Sewage is generated by residential, institutional, commercial and industrial establishments and includes household waste liquid from toilets, baths, showers, kitchens, and sinks draining into sewers. In many areas, sewage also includes liquid waste from industry and commerce. Treatment of wastewaters e.g. from sewers, generally involves three stages, called primary, secondary and tertiary treatment.

Wastewater contains a lot of different substances which are not desirable in water.

A pre-treatment removes all materials that can be easily collected from the raw sewage or wastewater before they damage or clog any pumps and sewage lines of primary treatment apparatuses. Objects commonly removed during pretreatment include trash, tree limbs, leaves, branches, and other large objects.

The primary treatment is designed to remove gross, suspended and floating solids from raw sewage. It includes screening to trap solid objects and sedimentation by gravity to remove suspended solids. This level is sometimes referred to as “mechanical treatment”, although chemicals are often used to accelerate the sedimentation process. Primary treatment is usually the first stage of wastewater treatment. The sludge, primary sludge, obtained at the primary treatment may be subjected to further treatment and reuse. The sludge may be composted, put on landfill, dewatered or dried to reduce the water content, and/or digested for methane production.

After the primary treatment, the wastewater is directed to a secondary treatment, which includes a biological treatment and removes the dissolved organic matter, phosphorus and nitrogen that escapes the primary treatment. This is achieved by microbes consuming the organic matter, and converting it to carbon dioxide, water, and energy for their own growth and reproduction.

Alternatively, wastewater may be subjected to enhanced biological phosphorus removal (EBPR) after the primary treatment.

Secondary treatment may require a separation process (“secondary sedimentation”) to remove the micro-organisms and more of the suspended solids from the treated water prior to discharge or the tertiary treatment.

Tertiary treatment is sometimes defined as anything more than primary and secondary treatment in order to allow rejection into a highly sensitive or fragile ecosystem (estuaries, low-flow rivers, coral reefs, etc). Treated water is sometimes disinfected chemically or physically (e.g. by lagoons and microfiltration) prior to discharge into recipient or reuse. An example of a typical tertiary treatment process is the modification of a conventional secondary treatment plant to remove additional phosphorus and/or nitrogen.

In an embodiment, the phosphorus may be precipitated immediately after the primary treatment.

The residue(s), i.e. the slurry or slurries, obtained at the above mentioned treatments is/are preferably put to good use. The slurries comprise phosphorous mainly in the form of phosphate(s), e.g. all or almost all phosphorous is present as phosphate. In some instances, the slurries contain phosphorous as phosphates and only comprise trace amounts of other phosphorous containing compounds. The slurry obtained in the second and/or third treatment steps is preferably the phosphorous containing material to be used to obtain said fertilizer. The slurry obtained from the secondary and tertiary treatment of wastewater may be mixed and together form the phosphorous containing material to be used to obtain said fertilizer.

In one embodiment according to the present invention, the phosphorous is preferably mainly kept in the water phase during the primary and secondary treatment and is precipitated mainly in the tertiary treatment. By doing so the concentration of phosphorous is increased in the tertiary slurry. That phosphorous rich slurry is a preferred ingoing material to be used in the production of a fertilizer. The phosphorous rich slurry is preferably obtained at a dewatering step of the tertiary treatment or a subsequent post-treatment step.

The dissolved phosphorus may be separated by chemical means, since almost all the dissolved phosphorus will be present as phosphate. For example, ferric or ferrous, aluminium, calcium or magnesium salts may be used to separate the dissolved phosphorus. Suitable salts include for example calcium hydroxide, calcium oxide, calcium chloride together with an alkaline, aluminium sulphate, aluminium chloride, polyaluminium chloride, polyaluminium sulphate, polyaluminium nitrate, aluminium chlorohydrate, sodium aluminate, ferric chloride, ferric sulphate, ferric chloro sulphate, ferrous chloride, ferrous sulphate, ferrous chloro sulphate, ferric hydroxide, or ferrous hydroxide. Sodium hydroxide may be used as an alkaline together with calcium chloride. These precipitates are then separated from the treated wastewater by physical means, for example by sedimentation, flotation, filtration or centrifugation, or any combination thereof. The separation methods may be performed using any one of a decanter centrifuge, hydrocyclone, screw press, disk filter, filter press, chamber filter press, and belt filter press, and any combination thereof. Also other phosphorus removal technologies may also be used in the treatment, like chemical-physical separations methods, may be used, such as ion exchange or adsorption to separate the dissolved phosphorus from the treated wastewater. It is to be noted that the precipitate separation may be carried out using multiple separation steps. These separations steps may include one or more separation devices, e.g. as mentioned above, in any combination.

Higher phosphorus recovery yield may be obtained by further processing sludges obtained in the wastewater treatment process by anaerobic digestion.

Phosphorus recovery yield may also be increased by treating primary and/or biological (secondary) sludge biologically, chemically or physically, or any combination of these, to release more phosphorus into water. Examples of suitable means are biological treatment in anaerobic, anoxic, micro-aerofilic or aerobic treatment, chemical treatment with ozone, hydrogen peroxide, performic acid, peracetic acid, or other strong chemical oxidants or reactants and by physical mean with for instance ultra sound, micro-screening and other physical processes.

By obtaining a phosphorous rich material, in the form of a sludge or slurry, at the end of the wastewater treatment, preferably at the end of the tertiary treatment, a significantly improved purity is found in said slurry. The phosphorous rich material is preferably a phosphate containing slurry. The phosphate containing slurry have a low content of impurities e.g. metals, such as heavy metals, which are undesirable in a fertilizer. In addition, no incineration of the phosphorous rich material, in the form of a sludge or slurry, is needed if the material is obtained from the very end of the treatment process, i.e. the tertiary treatment. Also, the high amount of phosphorous in the phosphate slurry obtained at the end of the wastewater treatment does not need any acidic extraction as is the case for rocks encapsulated phosphates, where acids are used. In the same manner also there is no need to use ammonia to increase the pH of the phosphate slurry as acids are not used in the obtaining of said slurry. If NPK or NP fertilizers are to be produced from the phosphorous containing material any nitrogen containing material may be added.

Ammonia is conventionally used due to its influence on pH in known processes. However, in the present process any nitrogen containing material is possible. Thus, this process provides for a wide variety of nitrogen containing compounds to be used as a nitrogen source in a fertilizer. Examples of suitable nitrogen containing compounds for the fertilizer are urea, ammonium sulphate, methylene urea, ammonia, ammonium chloride, mono ammonium phosphate, diammonium phosphate, ammonium nitrate, potassium nitrate, nitric acid, and nitrogen solutions of UAN (i.e. Urea and Ammonium Nitrate and water).

If NPK or PK fertilizers are to be produced from the phosphorous containing material any potassium containing material may be added, the potassium containing compounds may be selected from potassium sulphate, potassium chloride, potassium nitrate, potassium formiate, potassium phosphates (e.g. mono potassium phosphate, dipotassium phosphate and tripotassium phosphate).

As can be seen above, potassium nitrate may be used as both a potassium and a nitrogen additive.

Also additional phosphorous compound may be added to the fertilizer.

The phosphorous containing material include the phosphate obtained according to the present process, which may be any salt including a metal selected from the group calcium, magnesium, iron, aluminium, and other metals, and in any combination. In one embodiment the salt may contain at least one of calcium, iron, and aluminium, preferably selected from the group iron and aluminium. The phosphorous containing material may be iron phosphate.

The phosphate is recovered from the wastewater as a slurry, precipitate or dry particles, preferably as a slurry or precipitate. Hygienisation may be applied to the slurry or particles when needed. Chemical and/or thermal hygienisation may be used. It is to be noted that the thermal hygienisation is not to be confused with an incineration. An incineration is not preferable in the present invention as it hinders the biological availability of the phosphorous for plants. According to state of the art phosphorus may be concentrated by incineration which removes volatile compounds such as carbon, nitrogen and mercury. Incineration also has the feature of producing a pathogen free product due to the elevated temperatures used. However, incinerated waste materials have shown to provide phosphorus with lower biological availability. Thus, according to one embodiment of the present invention the treatment of sludges or slurries from wastewater treatments are not incinerated and/or heat treated at a temperature of at least 650° C.

The thermal hygienisation may be performed at temperatures of about 50-180° C., such as 50-120° C., 50-100° C., 70-95° C., or 70-80° C. Chemical hygienisation may be performed by addition of e.g. calcium hydroxide, calcium oxide, lime, performic acid, peracetic acid, hydrogen peroxide, ammonia. Hygienisation may also be performed using ozonization, or UV radiation. The phosphate can be used as such, as the only raw material in the fertilizer production to produce a phosphate fertilizer, or mixed with nitrogen and/or potassium compounds to produce NP, PK, or NPK fertilizers. Other nutrients or micronutrients can be added too. The new process is very simple, and may contain process steps selected from mixing of the desired raw materials, possible water addition, granulation chemically and/or mechanically, drying, cooling, sieving and coating, if needed. As an alternative, the simplest way is to utilize the nutrient mixture as such without any granulation and/or drying. Then it can be introduced in the form of slurry fertilizer for the plants. The obtained phosphate slurry or precipitate from the wastewater treatment, optionally with addition of additives mentioned herein and/or mixing thereof, may be dried as the only further treatment of the material before being used as a fertilizer, i.e. no granulation or pelletization is performed on the material.

If pellets or granules are produced these may be coated by a coating, preferably with a coating comprising any one selected from the group vegetable oil, mineral oil, palm oil, talc, and mica, and any combination thereof.

The phosphate of the fertilizer may be recovered from wastewater treatment plants as precipitate, slurry, or dry particles. The phosphorous content calculated on dry solids content may be about 4-30 wt %, such as 4-25 wt %, 4-17 wt %, 4-13 wt %, 6-13 wt %, 7-13 wt %, 8-13 wt %, or 8-12 wt %. These amounts are obtained in the precipitate from the wastewater plant.

The slurry obtained from the wastewater treatment may in addition to the phosphorous precipitate also include about 7-20% or 8-15% of organic compounds. These organic compounds may include some phosphorous atoms. The contents of any phosphorous within the organic compounds is minor and have been mentioned above as trace amounts of phosphorous in comparison with the phosphates provided in the precipitate.

The phosphates obtained from the wastewater treatment may be considered to release their phosphorous in a slower manner than completely water soluble phosphates due to the degradation period needed. Phosphate(s) obtained via the wastewater process described therein may often be selected from the group iron phosphates (e.g. ferric phosphate, ferrous phosphate, iron hydroxide phosphate), calcium phosphates (e.g. monocalcium phosphate, dicalcium phosphate, tricalcium phosphate, calcium hydroxide phosphate), aluminium phosphate, and magnesium ammonium phosphate. To provide a fertilizer including both a quick release and a slower or sustained release of phosphorous during the growth period of the plants, the phosphates obtained via the wastewater treatment process and other more quickly accessible phosphorous compounds can be combined. In one embodiment additional phosphorous containing compounds may be added to the fertilizer product. Such additions may be called start phosphorous that is the phosphorous the plant needs in the beginning of its growth, and may be compounds selected from the group monopotassium phosphate, dipotassium phosphate, tripotassium phosphate, monoammonium phosphate, diammonium phosphate, monocalcium phosphate, dicalcium phosphate. By combining the phosphates from the wastewater treatment with so called starter phosphates as is mentioned a fertilizer may be provided which provides fertilization for crops during the growth period.

The present process may provide a fertilizer which has a dry solids content of about 4-80 wt %, such as 5-70 wt %, 6-60 wt %, 7-50 wt %, 7-40 wt %, 7-30 wt %, and 8-20 wt %, when the final fertilizer is a dewatered slurry cake as such or mixed with other salts, e.g. those mentioned above.

If the fertilizer is provided using granulation or pelletizing, optionally with drying, the product will be dried more, resulting in a dry solids content of about 70-100 wt %, 80-99.8 wt %, 90-99.8 wt-%, 95-99.8 wt % or 98-99.5 wt %. Optionally the fertilizer is provided using drying without granulation or pelletizing the product will be dried to the same dry solids content of about as when using granulation or pelletizing.

The present fertilizer may have a pH of about 5-8, such as 5.5-7.5, or 6-7.

The present fertilizer may have a mean particle density of about 2.2-3.4 g/cm³, such as about 2.3-3.1 g/cm³, about 2.4-2.9 g/cm³, about 2.5-2.8 g/cm³ or about 2.6-2.8 g/cm³, if the phosphate precipitated in the process is ferric phosphate. The present fertilizer may have a mean particle density of about 2.1-3.2 g/cm³, such as about 2.2-2.9 g/cm³, about 2.3-2.8 g/cm³, about 2.4-2.7 g/cm³ or about 2.5-2.7 g/cm³, if the phosphate precipitated in the process is ferrous phosphate. The present fertilizer may have a mean particle density of about 1.8-3.0 g/cm³, such as about 1.9-2.7 g/cm³, about 2.0-2.5 g/cm³, about 2.1-2.4 g/cm³ or about 2.2-2.4 g/cm³, if the phosphate precipitated in the process is aluminium phosphate.

The present fertilizer may have a median particle size of about d(0.5) 10-50 μm, such as about 10-40 μm, or about 10-30 μm if the phosphate precipitated in the process is ferric phosphate (FePO₄) and particle size is measured using a Mastersizer. The d(0.5) values are respective 50% volume based percentiles. That is e.g. 50% of the particles are smaller than the value d(0.5). The d(0.5) is the median of the particle size distribution and it indicates the particle size which can be found in 50% of all particles.

When the fertilizer has been produced by pelletization or granulation the pellet or granule size after pelletization/granulation may for example be about 0.3-8 mm, such as 0.5-6 mm, 1-5 mm, or 2-4 mm.

The present fertilizer may have a particle size distribution of about 70% below 60 μm, for example about 80% below 60 μm, or about 90% below 60 μm, if the phosphate precipitated in the process is ferric phosphate (FePO₄) and particle size is measured using a Mastersizer.

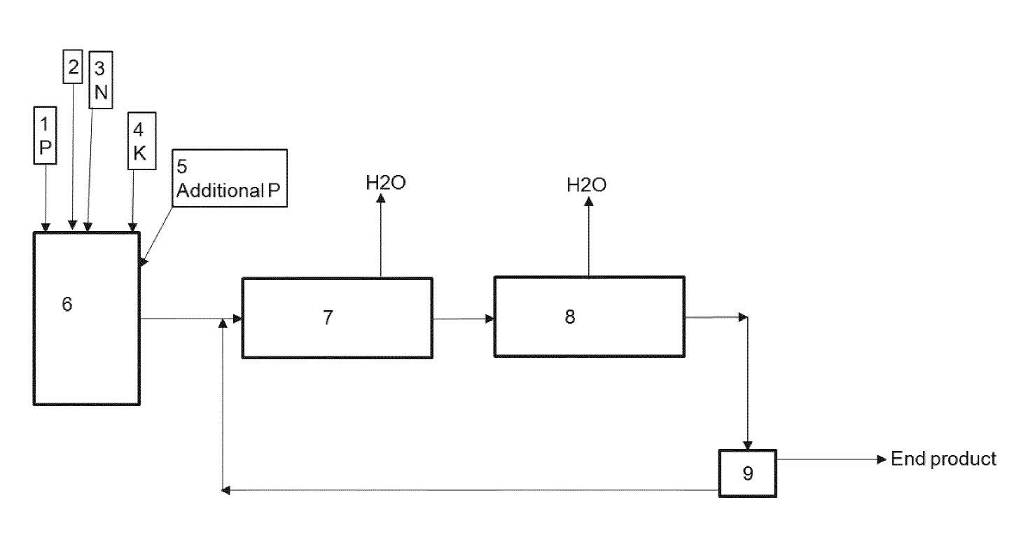

In FIG. 1 a possible set-up of the present process is presented. Recovered phosphate 1 from a wastewater treatment process is added to a mixing tank 6, optionally together with a choice of additives, e.g. selected from micronutrients and secondary nutrients 2, such micronutrients as e.g. iron, boron, copper, manganese, molybdenium, nickel, zinc and secondary nutrients as calcium, magnesium and sulphur; nitrogen containing compounds 3; potassium containing compounds 4; and additional phosphorous containing compounds 5 (e.g. water-soluble start phosphates). Also binders and fillers (e.g. cellulose or its derivatives, calcium sulphate dihydrate, anhydrous calcium sulphate, mica, perlite, or diatomeous earth) can be added but are not shown here. If no additional additives are added to the recovered phosphate a mixing tank 6 is not needed. Also, even if different additives are added to the recovered phosphate 1 the mixing tank and mixing is an optional feature and the components may be added directly to a granulator 7. The granulator 7 may be heated. During granulation water may be disposed of, e.g. evaporated. During granulation water may also be added to granulator 7 to support the granulation (not shown). After the granulator 7 the fertilizer pellet may be presented as a finished product. Optionally the fertilizer pellets or granules may be forwarded to a dryer 8 where more water may be evaporated and a more dry fertilizer pellets or granule is obtained. The fertilizer pellets or granules may also be forwarded to a sieve 9 to sort the sizes obtained and forwarding the desired size fraction for further use as a fertilizer. It is to be noted that the dryer 8 and sieve 9 are both optional. They may also be positioned in a reversed order compared to the disclosure of FIG. 1, or only one of them may be present in the process. Materials removed from the sieve 9 having undesirable size may be returned to the granulator 7 for further processing. Too large pellets or granules may be crushed before returned to the granulator (not shown). The obtained final endproduct may also be forwarded to a coating step (not shown) to further enhance the final product. Also the recovered phosphate with or without additives may be added directly to the dryer 8 without granulator 7 and then particulate product is obtained instead of pellets or granules.

The granulator 7 may be a pelletizing unit.

The present fertilizer comprising a phosphate obtained in a wastewater treatment process and its production method is disclosed further in the following examples.

### EXAMPLES

### Example 1

The phosphorus recovery in the tertiary treatment was simulated in the laboratory scale using wastewater from a wastewater treatment plant having a biological treatment process. As the wastewater treatment practices today require the removal of phosphorus, the total phosphorus in the wastewater was reduced to meet these requirements at the plant, to below 0.3 mgP/l. Thus the phosphorus level was first raised to the desired level using Na₃PO₄.

52.93 grams of Na₃PO₄ was dissolved into one liter of water. 1000 liters of wastewater was taken from the process and placed in a 1 m³ IBC-container that was equipped with a motor stirrer. Stirring was turned on and the prepared Na₃PO₄-solution was added into the mixing wastewater to raise the phosphorus level to 10 mgP/l. 241.7 g of PIX-111 (Fe 13.8%, density 1.42 g/ml) was fast added pouring from a bottle into a well-mixed container. Mixing was continued for 10 seconds after the PIX-111 addition, where after it was stopped. Precipitate was let to settle over 1 hour. Once it had settled, about 600 liters of the clear water from the surface of the container was carefully removed using a pump. The settled precipitate was separately collected and placed into a conical reactor where it was let to settle again. Once the precipitate had settled into the bottom of the conical reactor, it was carefully collected through the bottom valve and further dewatered with vacuum filtration in Buchner funnel in the lab scale. The wet cake contained 85% of water after the filtration in the lab. The dewatered cake was dried in the oven at 50° C. over the night, and the dried cake was analysed. A FePO₄ rich precipitate was obtained.

In table 1 below it is shown the measured values for phosphorus, iron, carbon and the metal impurities of the obtained precipitate, the measured phosphorus and carbon in regular sludge from the same plant as the precipitate, the limit values of metal impurities in accepted Finnish fertilizers, the measured values of standard sludges, and the limit values of metal impurities for sewage sludge according to the directive when sludge is used on the agricultural land.

In table 1 it is seen that FePO₄ precipitate is rich in phosphorus and contains higher amounts of phosphorus than the regular sludge from the same plant.

Table 1 shows clearly that a very pure FePO₄ containing precipitate was obtained. Very low amounts of metal impurities were measured and all these impurities were below the limit values of accepted fertilizers in Finland. The precipitate contained also lower amounts of impurities than the standard sludges.

Additionally, it can be seen FePO₄ precipitate contains lower amounts of metal impurities than standard sludges and is purer fertilizer material when compared to standard sludges to be used as such on agricultural land or in the fertilizer production process.

It can be seen that the organic carbon content of FePO₄ precipitate is much lower than in regular sludge from the same plant. Therefore, the organic impurities are also reduced in FePO₄ precipitate compared to regular sludge.

TABLE 1
Measured FePO₄ precipitate and regular sludge properties. Limit values for fertilizers in Finland.
Values for standard sewage sludges used on agricultural land in Finland, Sweden and Germany.
Limit values for sewage sludge used on agricultural land according to Directive 86/278/EEC.

| | Fe | P | Cd | As | Cr | Cu | Hg | Ni | Pb | Zn | Organic C |
|---|---|---|---|---|---|---|---|---|---|---|---|
| | (% of DS) | (% of DS) | (mg/kg of DS) | | | | | | | | (% of DS) |
| FePO₄ | 33.0 | 9.3 | 0.054 | 0.91 | 22 | 32 | 0.16 | 14 | 0.98 | 100 | 10 |
| precipitate | | | | | | | | | | | |
| from | | | | | | | | | | | |
| plant 1 | | | | | | | | | | | |
| Regular | | 3.5 | | | | | | | | | 32.3 |
| sludge, | | | | | | | | | | | |
| plant 1 | | | | | | | | | | | |
| Limit values | | — | 1.5 | 25 | 300 | 600 | 1 | 100 | 100 | 1500 | |
| for | | | | | | | | | | | |
| fertilizers | | | | | | | | | | | |
| in Finland | | | | | | | | | | | |
| Standard | | 2.4 | 0.6 | — | 18 | 244 | 0.4 | 30 | 8.9 | 332 | |
| sludge, | | | | | | | | | | | |
| Finland | | | | | | | | | | | |
| Standard | | 2.7 | 0.9 | — | 26 | 349 | 0.6 | 15 | 24 | 481 | |
| sludge, | | | | | | | | | | | |
| Sweden | | | | | | | | | | | |
| Standard | | 3.7 | 1 | — | 37 | 300 | 0.4 | 25 | 37 | 713 | |
| sludge, | | | | | | | | | | | |
| Germany | | | | | | | | | | | |
| Directive | | — | 20- | — | — | 1000- | 16- | 300- | 750- | 2500- | |
| 86/278/EEC | | | 40 | | | 1750 | 25 | 400 | 1200 | 4000 | |
| (current | | | | | | | | | | | |
| limits for | | | | | | | | | | | |
| sludge) | | | | | | | | | | | |

DS = dry solid content

Table 1 shows that by retrieving the phosphorus in the end of the wastewater treatment provides a phosphorus containing precipitate/slurry/material for use as fertilizer which has not only increased phosphorous content but contains also considerably lower amounts of unwanted metals compared to sludges which may have an output of phosphorous at earlier stages of the wastewater process.

For the phosphorous rich slurry, about 3 times as much phosphorous was obtained as the others. Also, the phosphorous rich slurry contained at most one eleventh of the amount of cadmium, one seventh of the amount of chromium, one ninth of the amount of lead, one third of zinc and less than half the amount of mercury found in the standard process sludges. From this it is clearly shown that in a preferred embodiment the fertilizer is made from slurries where phosphorous is not precipitated until the very end of the wastewater treatment process.

The FePO₄ precipitate from plant 1 mentioned herein is the type of precipitate that could be directly distributed as a fertilizer, without any further treatment, onto soils in need of fertilizing. Naturally, this type of precipitate could also be further treated to include nitrogen, potassium and/or additional phosphorous containing compounds. Also, the material could be further dried by evaporation of any water present and granulated, and optionally coated. Also the material could be only dried without any granulation and then a particulate product is obtained.

### Example 2

The obtained dewatered phosphate precipitate, FePO₄ precipitate, is mixed with urea (nitrogen source) and potassium chloride (potassium source) to produce a NPK-fertilizer. The following components and amounts are mixed: 300.0 g of urea (46.0 wt % N), 300.0 g of KCl (60 wt % K₂O=49.8 wt % K), and 3000.0 g of FePO₄ dewatered cake (9.0 wt % P of DS=20.6 wt % P₂O₅ of DS, and 90 wt % H₂O). The N, P₂O₅ and K₂O amounts in the final fertilizer on dry solid basis are 15.33 wt % N, 6.88 wt % P₂O₅ and 20.00 wt % K₂O. This slurry mixture contains 75% of H₂O and can be used as such as a slurry fertilizer. The N, P₂O₅ and K₂O amounts in this slurry fertilizer are 3.83 wt % N, 1.72 wt % P₂O₅ and 5.00 wt % K₂O.

Optionally the slurry can be fed into the granulator to produce a granulated fertilizer product and even further into the dryer to evaporate more water to produce granular, dried fertilizer product. Drying can be applied alone also without granulating. Optionally the granules can be sieved to the desired granule size. The final product granules can optionally be coated. In the granulator and dryer, the water content of the final product can be adjusted to the desired level.

Granulating and drying the slurry fertilizer to H₂O content of 0 wt % gives fertilizer granules that have 15.33 wt % N, 6.88 wt % P₂O₅, and 20.00 wt % K₂O. Granulating and drying to H₂O content of 0.5 wt %, fertilizer granules having 15.26 wt % N, 6.84 wt % P₂O₅ and 19.90 wt % K₂O are obtained. Drying, without granulating, to H₂O content of 0.5 wt %, fertilizer particles having 15.26 wt % N, 6.84 wt % P₂O₅ and 19.90 wt % K₂O are obtained. Granulating and drying to H₂O content of 1.0 wt %, fertilizer granules having 15.18 wt % N, 6.81 wt % P₂O₅ and 19.80 wt % K₂O are obtained. When fertilizer granules having 1 wt % H₂O are coated with 0.5 wt % of coating comprising of 3.0 g of vegetable oil and 1.6 g of talc, fertilizer granules having 15.10 wt % N, 6.77% P₂O₅ and 19.70 wt % K₂O are obtained.

TABLE 2

| | H₂O | Coating | N | P₂O₅ | K₂O |
|---|---|---|---|---|---|
| Fertilizer | wt % | wt % | wt % | wt % | wt % |
| Slurry fertilizer. | 75 | 0 | 3.83 | 1.72 | 5.00 |
| Mixture without any | | | | | |
| further process steps | | | | | |
| Granulated, dried product | 0 | 0 | 15.33 | 6.88 | 20.00 |
| Granulated, dried product | 0.5 | 0 | 15.26 | 6.84 | 19.90 |
| Particulate dried product | 0.5 | 0 | 15.26 | 6.84 | 19.90 |
| Granulated, dried product | 1.0 | 0 | 15.18 | 6.81 | 19.80 |
| Granulated, dried and | 1.0 | 0.5 | 15.10 | 6.77 | 19.70 |
| coated product | | | | | |

### Example 3

The obtained dewatered phosphate precipitate, FePO₄ precipitate is mixed with urea (nitrogen source), diammonium phosphate (nitrogen and start phosphorus source) and potassium chloride (potassium source) to produce a NPK-fertilizer. The following components and amounts are mixed: 291.5 g of urea (46.0 wt % N), 301.0 g of KCl (60 wt % K₂O=49.8 wt % K), 2000.0 g of FePO₄ dewatered cake (9.0 wt % P of DS=20.6 wt % P₂O₅ of DS, and 85 wt % H₂O) and 258.0 g of (NH₄)₂HPO₄ (46 wt % P₂O₅=20.1 wt % P, 18.0 wt % N). The N, P₂O₅ and K₂O amounts in the final fertilizer on dry solid basis are 15.69 wt % N, 15.69 wt % P₂O₅ and 15.70 wt % K₂O. This slurry mixture contains 59.64% of H₂O and can be used as such as a slurry fertilizer. The N, P₂O₅ and K₂O amounts in this slurry fertilizer are 6.33 wt % N, 6.33 wt % P₂O₅ and 6.34 wt % K₂O.

Optionally the slurry can be fed into the granulator to produce a granulated fertilizer product and even further into the dryer to evaporate more water to produce granular, dried fertilizer product. Drying can be applied alone also without granulating. Optionally the granules can be sieved to the desired granule size. The final product granules can optionally be coated. In the granulator and dryer, the water content of the final product can be adjusted to the desired level.

Granulating and drying the slurry fertilizer to H₂O content of 0 wt % gives fertilizer granules that have 15.69 wt % N, 15.69 wt % P₂O₅, and 15.70 wt % K₂O. Granulating and drying to H₂O content of 0.5 wt %, fertilizer granules having 15.61 wt % N, 15.62 wt % P₂O₅ and 15.62 wt % K₂O are obtained. Drying, without granulating, to H₂O content of 0.5 wt %, fertilizer particles having 15.61 wt % N, 15.62 wt % P₂O₅ and 15.62 wt % K₂O are obtained. Granulating and drying to H₂O content of 1.0 wt %, fertilizer granules having 15.54 wt % N, 15.54 wt % P₂O₅ and 15.54 wt % K₂O are obtained. When fertilizer granules having 1 wt % H₂O are coated with 0.5 wt % of coating comprising of 3.0 g of vegetable oil and 2.8 g of talc, fertilizer granules having 15.46 wt % N, 15.46% P₂O₅ and 15.46 wt % K₂O are obtained.

TABLE 3

| | H₂O | Coating | N | P₂O5 | K₂O |
|---|---|---|---|---|---|
| Fertilizer | wt % | wt % | wt % | wt % | wt % |
| Slurry fertilizer. | 59.64 | 0 | 6.33 | 6.33 | 6.34 |
| Mixture without any | | | | | |
| further process steps | | | | | |
| Granulated, dried product | 0 | 0 | 15.69 | 15.69 | 15.70 |
| Granulated, dried product | 0.5 | 0 | 15.61 | 15.62 | 15.62 |
| Particulate dried product | 0.5 | 0 | 15.61 | 15.62 | 15.62 |
| Granulated, dried product | 1 | 0 | 15.54 | 15.54 | 15.54 |
| Granulated, dried and | 1 | 0.5 | 15.46 | 15.46 | 15.46 |
| coated product | | | | | |

### Example 4

Ferric sulphate, Kemira PIX-105 (Fe 11.2 w-%, density 1.50 g/cm³) was used at the wastewater treatment plant (plant 2) to precipitate the phosphorus in the post-precipitation step from the otherwise purified wastewater before releasing water to the recipients. During the sampling period, the wastewater flow was 20700-21900 m³/d, PIX dosage 1820-2210 kg/d and PO₄—P in the water 1.1-2.3 mg/I. A phosphate precipitate was formed. The precipitate was let to settle in the settling tank and the settled slurry was further dewatered using a decanter centrifuge. A flocculant, Kemira Superfloc A120HMW, was added to the settling and dewatering to improve the solid liquid separation. The flocculant was used as 0.02-0.05% solution.

A 5 kg sample of the dewatered phosphate cake was taken daily during four days. The taken 5 kg samples were combined and homogenized by mixing with a concrete mixer. Two collected, homogenized samples were prepared similarly (Sample 1 and Sample 2). Regular dewatered sewage sludge from the same plant was collected similarly from the plant's decanter centrifuge (Sample 3). The properties of the samples are presented in Table 4.

TABLE 4
Inorganic and carbon analysis results of the prepared samples.

| | Fe | P | Cd | Cr | Cu | Hg | Ni | Pb | Zn | Organic C |
|---|---|---|---|---|---|---|---|---|---|---|
| | (% of DS) | (% of DS) | (mg/kg of DS) | | | | | | | (% of DS) |
| Sample 1 (collected | 34.5 | 7.1 | <0.3 | 13 | 17 | <0.05 | 62 | <0.3 | 1100 | 8.5 |
| dewatered | | | | | | | | | | |
| precipitate, plant 2) | | | | | | | | | | |
| Sample 2 (collected | 31.4 | 6.5 | <0.3 | 12 | 22 | <0.05 | 61 | <0.3 | 650 | 12.6 |
| dewatered | | | | | | | | | | |
| precipitate, plant 2) | | | | | | | | | | |
| Sample 3 (collected | 4.6 | 2.3 | <0.3 | 21 | 60 | 0.2 | 18 | <0.3 | 830 | 41.5 |
| dewatered regular | | | | | | | | | | |
| sewage sludge, | | | | | | | | | | |
| plant 2) | | | | | | | | | | |

DS = dry solid content at 105° C., 24 hours.

The phosphorus content in post-precipitated, dewatered phosphate cake is about three times higher than in regular sewage sludge from the same plant. Carbon content is 3-4.9 times lower in the dewatered phosphate cake than in the regular sewage sludge.

The measured Escherichia coli bacteria in Sample 1 was 580 MPN/g, in Sample 2 it was 550 MPN/g and in Sample 3 it was >24000 MPN/g. This shows that the phosphorus precipitate contains very much lower amounts of undesired bacteria than the regular sewage sludge from the same plant. The particle size of Sample 1 and 2 was analyzed using Malvern Mastersizer 2000 analyser. The results are presented in Table 5. A small amount of sample was measured in deionized water with a stirrer at 1500 rpm. The reported d(0.1), d(0.5) and d(0.9) values are the respective 10%, 50% and 90% volume based percentiles. That is e.g. 10% of the particles are smaller than the given value d(0.1) in μm. The d(0.5) is the median of the particle size distribution and it indicates the particle size which can be found in 50% of all particles.

TABLE 5
Particle size results of the collected samples.

| | | | | D[3.2]- | D[4.3]- |
|---|---|---|---|---|---|
| | | | | surface | volume |
| | d(0.1) | d(0.5) | d(0.9) | weighted | weighted |
| | μm | μm | μm | mean μm | mean μm |
| Sample 1 | 3.5 | 12.3 | 66.0 | 8.2 | 35.2 |
| (collected | | | | | |
| precipitate, | | | | | |
| plant 2) | | | | | |
| Sample 2 | 3.5 | 11.2 | 48.9 | 24.5 | 81.1 |
| (collected | | | | | |
| precipitate, | | | | | |
| plant 2) | | | | | |

### Example 5

100 kg sample of dewatered phosphate cake was taken from the decanter centrifuge from the wastewater treatment process (plant 2) described in Example 4. 25 kg of this dewatered cake was spread on five large plates and dried in the oven that was equipped with an air circulation at two different conditions: at 42° C. for 6 nights, and at 100° C. for one night. Properties of the obtained crystals were analyzed (Table 6).

TABLE 6
Measured properties of the dried phosphate samples.

| | | Sample dried at | Sample dried at |
|---|---|---|---|
| | | 42° C., 6 nights | 100° C., one night |
| True density | g/cm³ | 2.49 | 2.64 |
| DS | % | 87.0 | 97.6 |
| P | % | 6.4 | 7.5 |
| Fe | % | 30.0 | 35.0 |
| TOC | % | 8.3 | 9.2 |

DS = dry solid content at 105° C., 24 hours,
TOC = total organic carbon

### Example 6

25 kg of the obtained dewatered phosphate cake from the plant 2 was spread on five large plates and dried in an oven that was equipped with air circulation at 100° C. for 24 hours. The composition of the dried material is presented in Table 7.

TABLE 7
The composition of phosphate precipitate
when dried at 100° C. for 24 hours.

| | Unit | Result |
|---|---|---|
| P | % | 7.8 |
| Fe | % | 33.0 |
| N | % | 1.2 |
| DS | % | 97.4 |
| TOC | % | 8.0 |
| TC | % | 8.2 |
| IC | % | 0.2 |

TOC = total organic carbon,
TC = total carbon,
IC = inorganic carbon,
DS = dry solid content at 105° C., 24 hours

This dried phosphate precipitate was crushed and sieved to below 1.0 mm particle size, and used for granulating N-P-K fertilizer.

a) Recipe 1.

448.76 g of so prepared dried phosphate precipitate was taken and mixed with 1277, 89 g of ammonium sulphate (NH₄)₂SO₄ for analysis, 1.01217.5000, from Merck, and with 233.35 g of potassium sulphate K₂SO₄ GPR Rectapur, 26994.362, from VWR Chemicals. The obtained mixture was grinded twice using Retsch mill Type SR2. 100 g of so prepared grinded salt mixture was placed on a laboratory scale plate granulator from Mars Mineral, Model No. DP-14 with a diameter of 36 cm. The plate was switched on and let to rotate at the speed of 40 rpm. The granulation was started and the salt bed was gently moved on the plate with the help of a small shovel. During the granulation, small portions of water was sprayed on the moving salt bed to support the formation of the granules. Once the first initial granules were formed, a small portion of the salt mixture was added to the plate. Always when needed, water was sprayed evenly in small portions to the salt mixture to support the granulation. Granules were let to grow, and always the next salt addition was done when the loose grinded salt had been consumed to the granule formation. All the grinded salt was consumed. During the granulation, totally 230 g of H₂O was used in the granulation. The granulation time was 1 hour. The obtained granules were dried in the oven at 80° C. for 3 hours, and continued at 60° C. over the night.

b) Recipe 2.

702.44 g of so prepared dried phosphate precipitate was taken and mixed with 1147.98 g of ammonium sulphate (NH₄)₂SO₄ for analysis, 1.01217.5000, from Merck, and with 109.58 g of potassium chloride KCl, GPR Rectapur, 26759.462, from VWR Chemicals. The obtained mixture was grinded twice using Retsch mill Type SR2. 100 g of so prepared grinded salt mixture was placed on a laboratory scale plate granulator from Mars Mineral, Model No. DP-14 with a diameter of 36 cm. The plate was switched on and let to rotate at the speed of 40 rpm. The granulation was started and the salt bed was gently moved on the plate with the help of a small shovel. During the granulation, small portions of water was sprayed on the moving salt bed to support the formation of the granules. Once the first initial granules were formed, a small portion of the salt mixture was added to the plate. Always when needed, water was sprayed evenly in small portions to the salt mixture to support the granulation. Granules were let to grow, and always the next salt addition was done when the loose grinded salt had been consumed to the granule formation. All the grinded salt was consumed. During the granulation, 240 g of H₂O was sprayed evenly and slowly on the forming granules to support the granule formation. The granulation time was 1 hour. The obtained granules were dried in the oven at 80° C. for 2 hours, and continued at 60° C. over the night.

c) Reference recipe.

A granulation without dried phosphate precipitate was prepared, using only traditional, commercially available fertilizer salts. 1128.43 g of ammonium sulphate (NH₄)₂SO₄ for analysis, 1.01217.5000, from Merck, was taken and mixed with 233.35 g of potassium sulphate K₂SO₄ GPR Rectapur, 26994.362, from VWR Chemicals, 174.37 g of di-ammonium hydrogen phosphate, technical grade, 21306.362, from VWR Chemicals, and 423.85 g of calcium sulphate dihydrate CaSO4.2H₂O waste from Siilinjärvi (binder). The obtained mixture was grinded twice using Retsch mill Type SR2. 100 g of so prepared grinded salt mixture was placed on a laboratory scale plate granulator from Mars Mineral, Model No. DP-14 with a diameter of 36 cm. The plate was switched on and let to rotate at the speed of 40 rpm. The granulation was started and the salt bed was gently moved on the plate with the help of a small shovel. During the granulation, small portions of water was sprayed on the moving salt bed to support the formation of the granules. Once the first initial granules were formed, a small portion of the salt mixture was added to the plate. Always when needed, water was sprayed evenly in small portions to the salt mixture to support the granulation. Granules were let to grow, and always the next salt addition was done when the loose grinded salt had been consumed to the granule formation. All the grinded salt was consumed. During the granulation, 200 g of H₂O was sprayed evenly and slowly on the forming granules to support the granule formation. The granulation time was 1 hour. The obtained granules were dried in the oven at 80° C. for 6 hours, and continued at 60° C. over the night.

The obtained properties of the prepared fertilizers according to Recipe 1, Recipe 2 and Reference recipe are presented in Table 8.

TABLE 8
Fertilizer properties.

| | | | | Reference |
|---|---|---|---|---|
| | | Recipe 1 | Recipe 2 | recipe |
| N | % | 11.0 | 11.0 | 14.0 |
| P | % | 1.8 | 2.5 | 2.1 |
| P₂O₅ | % | 4.1 | 5.7 | 4.8 |
| K | % | 5.5 | 3.2 | 5.6 |
| K₂O | % | 6.6 | 3.9 | 6.7 |
| Fe | % | 7.5 | 11.0 | 0.082 |
| DS | % | 95.0 | 93.8 | 98.7 |
| TOC | % | 1.9 | 2.7 | <0.1 |
| TC | % | 1.9 | 2.7 | <0.1 |
| IC | % | <0.1 | <0.1 | <0.1 |
| Granule | g | 4320 | 5479 | 5096 |
| strength | | | | |
| (dry) | | | | |
| Sieve | <1 mm, % | 4.4 | 2.3 | 2.5 |
| analysis, | 1-8 mm, % | 80 | 78 | 89 |
| portion of | 1-5 mm, % | 60 | 32 | 79 |
| granules | 3-5 mm, % | 25 | 20 | 52 |

TOC = total organic carbon,
TC = total carbon,
IC = inorganic carbon,
DS = dry solid content at 105° C., 24 hours.

All the fertilizers granulated well. Granule strengths were good.

The following N-P-K fertilizers were obtained (N expressed as N-%, P expressed as P₂O₅-% and K expressed as K₂O-%):

Recipe 1: N-P-K 11-4,1-6,6

Recipe 2: N-P-K 11-5,7-3,9

Reference recipe: N-P-K 14-4,8-6,7.

1. A process for the production of a phosphate containing fertilizer product, comprising the steps of:
providing a phosphate containing precipitate from a wastewater treatment process,
separating water from the precipitate to provide a dewatered slurry cake, and
optionally adding or admixing at least one compound selected from nitrogen, potassium and additional phosphorous containing compounds.

2. The process according to claim 1, wherein the phosphate containing precipitate is precipitated from the water phase in a tertiary treatment of the wastewater treatment process.

3. The process according to claim 1, wherein the phosphate of the phosphate containing precipitate is a salt selected from the group iron phosphates, calcium phosphates, aluminium phosphates, and magnesium ammonium phosphate, preferably selected from the group ferric phosphate, ferrous phosphate, iron hydroxide phosphate, monocalcium phosphate, dicalcium phosphate, tricalcium phosphate, calcium hydroxide phosphate, aluminium phosphate, and magnesium ammonium phosphate, preferably selected from the group ferric phosphate, ferrous phosphate, iron hydroxide phosphate and aluminium phosphate.

4. The process according to claim 1, wherein the nitrogen containing compounds may be selected from the group urea, ammonium sulphate, methylene urea, ammonia, ammonium chloride, mono ammonium phosphate, diammonium phosphate, ammonium nitrate, potassium nitrate, nitric acid, and nitrogen solutions of UAN (urea and ammonium nitrate and optionally water), and any combination thereof.

5. The process according to claim 1, wherein the potassium containing compounds may be selected from the group potassium sulphate, potassium chloride, potassium nitrate, potassium phosphate and potassium formiate, and any combination thereof.

6. The process according to claim 1, wherein the dewatered slurry cake has a dry solids content of 4-80 wt %, preferably selected from any one of the ranges 5-70 wt %, 6-60 wt %, 7-50 wt %, 7-40 wt %, 7-30 wt %, and 8-20 wt %.

7. The process according to claim 1, wherein the dewatered slurry cake has a phosphorous content calculated on dry solids content of 30 wt %, preferably selected from any one of the ranges 4-25 wt %, 4-17 wt %, 4-13 wt %, 6-13 wt %, 7-13 wt %, 8-13 wt %, or 8-12 wt %.

8. The process according to claim 1, wherein the process further comprises a hygienisation step, preferably selected from thermal hygienisation, chemical hygienisation, ozonization, or UV radiation.

9. The process according to claim 8, wherein the thermal hygienisation is performed at temperatures of 50-180° C., preferably 50-120° C., preferably 50-100° C., preferably 70-95° C., and preferably 70-80° C.

10. The process according to claim 8, wherein the chemical hygienisation is performed by addition of a compound selected from the group calcium hydroxide, calcium oxide, lime, performic acid, peracetic acid, hydrogen peroxide, and ammonia, and any combination thereof.

11. The process according to claim 1, wherein the process further comprises the steps of:
optionally mixing said slurry,
optionally adding water, and
pelletizing or granulating the slurry to obtain pellets and granules, respectively.

12. The process according to claim 1, wherein the process further comprises the step of drying the dewatered slurry cake and/or the formed pellets or granules.

13. The process according to claim 11, wherein the dried dewatered slurry cake and/or the optionally dried formed pellets or granules have a dry solids content selected from the group of ranges of 70-100 wt %, 80-99.8 wt %, 90-99.8 wt %, 95-99.8 wt %, and 98-99.5 wt %.

14. The process according to claim 1, wherein the process further comprises the step(s) of cooling of the pellets or granules, and/or screening of the pellets or granules, in any order.

15. The process according to claim 1, wherein the process further comprises the step of coating of the pellets or granules, preferably with a coating comprising a compound selected from the group vegetable oil, mineral oil, palm oil, talc, and mica, and any combination thereof.

16. A fertilizer comprising a phosphate obtained from a wastewater treatment process.

17. A fertilizer obtained from the process according to claim 1.

18. A method of using a phosphate obtained from a wastewater treatment in the production of a fertilizer.

19. Method of using a fertilizer according to claim 16, on cultivation media, preferably soil.

20. The process according to claim 1, wherein the phosphate is any salt including a metal selected from the group calcium, magnesium, iron, aluminium, and any combination thereof, preferably selected from calcium, iron, and aluminium, and any combination thereof, preferably selected from iron and/or aluminium.

21. The process according to claim 1, wherein the fertilizer has a pH of 5-8, preferably 5.5-7.5, and preferably 6-7.

22. Method of using a fertilizer obtained in the process according to claim 1, on cultivation media, preferably soil.

23. The fertilizer according to claim 16, wherein the phosphate is any salt including a metal selected from the group calcium, magnesium, iron, aluminium, and any combination thereof, preferably selected from calcium, iron, and aluminium, and any combination thereof, preferably selected from iron and/or aluminium.

24. The fertilizer according to claim 16, wherein the fertilizer has a pH of 5-8, preferably 5.5-7.5, and preferably 6-7.
